(19) United States
(12) Patent Application Publication
(10) Pub. No.: US 2026/0149505 A1
(43) Pub. Date: May 28, 2026

(54) OPTICAL BEAM TRANSMISSION DEVICE

(71) Applicant: Mitsubishi Electric Corporation, Tokyo (JP)

(72) Inventors: Tomohiro AKIYAMA, Tokyo (JP); Eisuke HARAGUCHI, Tokyo (JP)

(73) Assignee: Mitsubishi Electric Corporation, Tokyo (JP)

(21) Appl. No.: 19/449,692

(22) Filed: Jan. 15, 2026

Related U.S. Application Data
(63) Continuation of application No. PCT/JP2023/032167, filed on Sep. 4, 2023.

(51) Int. Cl. H04B 10/548; H04L 7/00

(52) U.S. Cl. CPC H04B 10/548; H04L 7/0075

(57) ABSTRACT

An optical beam transmission device incudes: a light distributor to split a laser beam; an optical frequency shifter to shift a frequency of the local light beam; a collimating lens to convert the local light beam; an optical phase shifter to change a phase of a corresponding transmission light beam; an optical modulator to modulate a transmission light beam; an optical amplifier to amplify intensity of the transmission light; an optical collimator array to convert the transmission light beam after amplification; an optical beam splitter to split and synthesize some of the transmission beams to obtain synthesized phase monitoring light; a photoelectric converter to photoelectrically convert corresponding synthesized phase monitoring light; a modulated electrical signal outputter to output a modulated electrical signal having a controlled delay time; and an optical phase synchronization controller to detect a phase of an electrical signal and output a control signal.

### CROSS REFERENCE TO RELATED APPLICATION

This application is a Continuation of PCT International Application No. PCT/JP2023/032167, filed on September 4, 2023, which is hereby expressly incorporated by reference into the present application.

### TECHNICAL FIELD

The present disclosure relates to an optical beam transmission device that synthesizes a plurality of optical beams in phase synchronization.

### BACKGROUND ART

Conventionally, a device that transmits a high-power optical beam to a distant place such as optical spatial communication or optical energy transmission is known. In this device, transmission power per beam is limited due to limitation of power resistance of an optical fiber amplifier or an optical fiber that transmits output light thereof.

As a means for overcoming such a limitation, there is a spatial phase synthesis (CBC: Coherent Beam Synthesis) technique. In this spatial phase synthesis technique, a plurality of optical beams is transmitted in an array, and optical beams are synthesized in space by aligning phases between the optical beams.

Here, in order to synthesize phases of optical beams having a wavelength on the order of um, it is necessary to align optical path length variations between the optical beams within the same order of um. However, generally, the phase of an optical wave transmitted through a different optical path such as an optical fiber or an optical fiber amplifier varies due to environmental variations such as temperature.

In the related art, an optical beam (local beam) serving as a reference wavefront (phase) is spatially synthesized with each transmission beam, and each transmission beam and the local beam are photoelectrically converted to be converted into a heterodyne beat signal. Then, in the related art, a phase error of each transmission signal is detected from phase information of the heterodyne beat signal, and the phase of each transmission signal is corrected on the basis of the phase information, thereby transmitting the phase-synchronized arrayed optical beams. In this way, in the related art, phase synthesis is performed in space.

Furthermore, in order to transmit a high-output optical beam, it is necessary to increase the number of beams and to increase the intensity of each optical beam. However, when an optical beam transmits through an optical fiber, such as an optical fiber amplifier, the intensity transmitted through the optical fiber is limited, such as by stimulated Brillouin scattering (SBS) due to non-linearity of the optical fiber. SBS is more likely to occur as the line width of an optical beam is narrower. Therefore, in order to suppress occurrence of SBS, it is desirable that the line width of an optical beam is wide, and when the line width of an optical beam output from a laser light source is narrow, it is necessary to increase the line width.

In a technique disclosed in Non Patent Literature 1, a laser beam output from a light source (MO) is phase-modulated (25 GHz Φ-mod) with a broadband signal to expand a line width of the laser beam. Non Patent Literature 1 also suggests use of a pseudo random bit sequence (PRBS).

On the other hand, when the line width of the laser beam is increased, it is necessary to match actual lengths of transmission paths among transmission light paths on the order of the reciprocal of the line width or less. When the line width is on the order of several tens GHz, the actual length of the fiber needs to be matched within the order of mm or less. Furthermore, in order to phase-synthesize the optical beams, it has to be stabilized on the order of the wavelength of light or less (< 1 μm).

Accordingly, in the technique disclosed in Non Patent Literature 1, a variable delay line (VDL) is provided in an optical path of transmission light beam. Thus, in the technique disclosed in Non Patent Literature 1, optical path lengths are matched, and optical phase variations between optical paths are suppressed by an optical phase shift modulator (φMod).

### CITATION LIST

### NON PATENT LITERATURE

Non Patent Literature 1: Angel Flores, Chunte Lu, Craig Robin, Shadi Naderi, Christopher Vergien, Iyad Dajani, “Experimental and theoretical studies of phase modulation in Yb-doped fiber amplifiers,” Proc. SPIE 8381, Laser Technology for Defense and Security VIII, 83811B (21 May 2012)

### SUMMARY OF INVENTION

### TECHNICAL PROBLEM

In the technique disclosed in Non Patent Literature 1, a line width of a laser beam output from a light source (MO) is expanded (Line Broadening), then divided into a plurality of optical paths, amplified by an optical amplifier, and then spatially synthesized (coherent beam synthesis). At this time, in the technique disclosed in Non Patent Literature 1, in order to have a correlation between optical beams in a state where the line width is expanded, the actual lengths of optical paths are equalized with each other by the variable delay line, and in order to perform coherent synthesis of light, phase fluctuation between the paths is compensated.

However, when the enlarged width (frequency) of the line width increases, an allowable error with respect to the actual lengths between the optical paths decreases. For this reason, it is difficult to carry out manufacturing with matched optical path lengths until a laser beam is emitted from a collimator to the space after the laser beam is distributed. Further, even in a case where adjustment is performed using a variable delay line in order to compensate for this error, there are problems such as being limited to a control range of the variable delay line, and a loss may fluctuate due to control of a delay amount.

The present disclosure has been made to solve the above problems, and an object thereof is to provide an optical beam transmission device capable of relaxing manufacturing requirements as compared with the related art.

### SOLUTION TO PROBLEM

A high brightness optical beam transmission device according to the present disclosure includes: a light distributor to split a laser beam into one local light beam and a transmission light beam for each of paths; an optical frequency shifter to shift a frequency of the local light beam obtained by the light distributor; a collimating lens to convert the local light beam after the frequency shift by the optical frequency shifter into a local beam that is a parallel beam; an optical phase shifter provided for each of the paths to change a phase of a corresponding transmission light beam obtained by the light distributor in accordance with a control signal; an optical modulator provided for each of the paths to modulate a transmission light beam after a phase change by the corresponding optical phase shifter in accordance with a modulated electrical signal; an optical amplifier provided for each of the paths to amplify intensity of the transmission light beam after modulation by the corresponding optical modulator; an optical collimator array provided for each of the paths to convert the transmission light beam after amplification by the corresponding optical amplifier into a transmission beam that is a parallel beam; an optical beam splitter to split some of transmission beams obtained by the optical collimator array for each of the paths and synthesize said some of the transmission beams with the local beam obtained by the collimating lens to obtain synthesized phase monitoring light; a photoelectric converter provided for each of the paths to photoelectrically convert corresponding synthesized phase monitoring light obtained by the optical beam splitter to obtain an electrical signal; a modulated electrical signal outputter to output a modulated electrical signal having a controlled delay time to each of the optical modulators for each of the paths on a basis of the electrical signal obtained by the photoelectric converter for each of the paths; and an optical phase synchronization controller provided for each of the paths to detect a phase of an electrical signal obtained by the corresponding photoelectric converter, and output a control signal based on the phase to the corresponding optical phase shifter.

### ADVANTAGEOUS EFFECTS OF INVENTION

According to the present disclosure, with the above configuration, it is possible to relax manufacturing requirements as compared with the related art.

### BRIEF DESCRIPTION OF DRAWINGS

FIG. 1 is a diagram illustrating a configuration example of an optical beam transmission device according to a first embodiment.

FIGS. 2A to 2E are schematic diagrams illustrating an example of frequency arrangement of optical and electrical signals in each unit of the optical beam transmission device according to the first embodiment.

FIG. 3 is a diagram illustrating a configuration example of an optical beam transmission device according to a second embodiment.

FIG. 4 is a diagram illustrating a configuration example of an optical frequency synchronization control means in the second embodiment.

FIGS. 5A to 5E are schematic diagrams illustrating an example of frequency arrangement of optical and electrical signals in each unit of the optical beam transmission device according to the second embodiment.

FIG. 6 is a diagram illustrating a configuration example of an optical beam transmission device according to a third embodiment.

FIG. 7 is a diagram illustrating a configuration example of an optical beam transmission device according to a fourth embodiment.

FIGS. 8A and 8B are diagrams illustrating a hardware configuration example of the optical beam transmission devices according to the first to fourth embodiments.

### DESCRIPTION OF EMBODIMENTS

Hereinafter, embodiments will be described in detail with reference to the drawings.

### First Embodiment

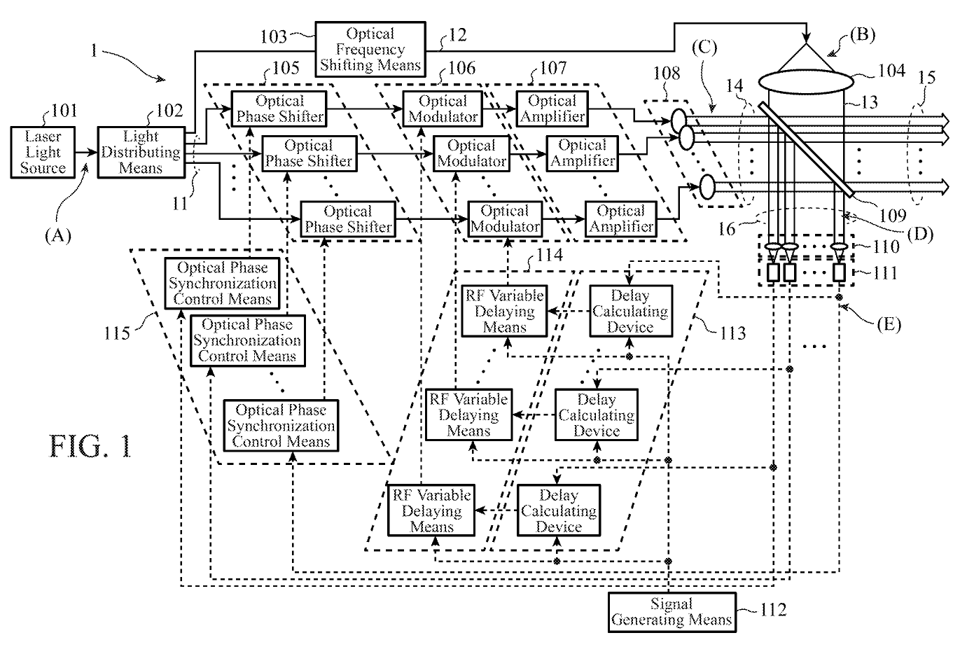

FIG. 1 is a diagram illustrating a configuration example of an optical beam transmission device 1 according to a first embodiment. Note that, in FIG. 1, a solid arrow indicates a flow of an optical signal, and a broken arrow indicates a flow of an electrical signal (including a high-frequency signal (microwave signal)).

As illustrated in FIG. 1, the optical beam transmission device 1 includes a laser light source 101, a light distributing means 102, an optical frequency shifting means 103, a collimating lens 104, a plurality of optical phase shifters 105, a plurality of optical modulators 106, a plurality of optical amplifiers 107, an optical collimator array 108, an optical beam splitting means 109, a plurality of beam condensing means 110, a plurality of photoelectric converting means 111, a signal generating means 112, a plurality of delay calculating devices 113, a plurality of RF variable delaying means 114, and a plurality of optical phase synchronization control means 115.

Further, although reference numerals are not indicated in FIG. 1, in the optical beam transmission device 1, optical phase shifters 105-1 to 105-n are provided as the plurality of optical phase shifters 105, optical modulators 106-1 to 106-n are provided as the plurality of optical modulators 106, optical amplifiers 107-1 to 107-n are provided as the plurality of optical amplifiers 107, beam condensing means 110-1 to 110-n are provided as the plurality of beam condensing means 110, photoelectric converting means 111-1 to 111-n are provided as the plurality of photoelectric converting means 111, delay calculating devices 113-1 to 113-n are provided as the plurality of delay calculating delay calculating devices 113, RF variable delaying means 114-1 to 114-n are provided as the plurality of RF variable delaying means 114, and optical phase synchronization control means 115-1 to 115-n are provided as the plurality of optical phase synchronization control means 115. Note that -1 to -n represent element (path) numbers of the array, and the number of elements is-n.

The laser light source 101 generates a laser beam.

The laser beam generated by the laser light source 101 is output to the light distributing means 102.

The light distributing means 102 branches the laser beam output from the laser light source 101 into one local light beam and a transmission light beam for each of paths. That is, the light distributing means 102 branches the laser beam into (n+1) pieces.

The local light beam obtained by the light distributing means 102 is output to the optical frequency shifting means 103. Further, the transmission light beam for each of the paths obtained by the light distributing means 102 is output to the corresponding optical phase shifter 105. Note that, in FIG. 1, reference numeral 11 denotes the transmission light beam.

The optical frequency shifting means 103 shifts the frequency of the local light beam obtained by the light distributing means 102.

The local light beam whose frequency has been shifted by the optical frequency shifting means 103 is output to the collimating lens 104. In FIG. 1, reference numeral 12 denotes the local light beam.

As the optical frequency shifting means 103, for example, an acousto-optical modulator (AOM), a modulator using LiNbO3, or the like is used.

The collimating lens 104 converts a local light beam whose frequency has been shifted by the optical frequency shifting means 103 into a local beam that is a parallel beam.

The local beam obtained by the collimating lens 104 is output to the optical beam splitting means 109. Note that, in FIG. 1, reference numeral 13 denotes a local beam.

The optical phase shifter 105 is provided for each of the paths.

The optical phase shifter 105 changes the phase (transmission phase) of the corresponding transmission light beam obtained by the light distributing means 102 in accordance with a control signal from the corresponding optical phase synchronization control means 115.

The transmission light beam after the phase change by the optical phase shifter 105 is output to the corresponding optical modulator 106.

In the example of FIG. 1, the optical phase shifter 105-1 changes the phase (transmission phase) of the corresponding transmission light beam obtained by the light distributing means 102 in accordance with a control signal from the optical phase synchronization control means 115-1. The transmission light beam after the phase change by the optical phase shifter 105-1 is output to the optical modulator 106-1.

In addition, the optical phase shifter 105-2 changes the phase (transmission phase) of the corresponding transmission light beam obtained by the light distributing means 102 in accordance with a control signal from the optical phase synchronization control means 115-2. The transmission light beam after the phase change by the optical phase shifter 105-2 is output to the optical modulator 106-2.

In addition, the optical phase shifter 105-n changes the phase (transmission phase) of the corresponding transmission light beam obtained by the light distributing means 102 in accordance with the control signal from the optical phase synchronization control means 115-n. The transmission light beam after the phase change by the optical phase shifter 105-n is output to the optical modulator 106-n.

The optical modulator 106 is provided for each of the paths.

The optical modulator 106 modulates the transmission light beam after the phase change by the corresponding optical phase shifter 105 in accordance with a modulated electrical signal from the corresponding RF variable delaying means 114.

The transmission light beam modulated by the optical modulator 106 is output to the corresponding optical amplifier 107.

As the optical modulator 106, for example, a phase modulator, an intensity modulator, or the like is used. Note that, as the optical modulator 106, a phase modulator in which the average intensity of the output light does not vary depending on an input RF signal is desirable.

In the example of FIG. 1, the optical modulator 106-1 modulates the transmission light beam after the phase change by the optical phase shifter 105-1 in accordance with the modulated electrical signal from the RF variable delaying means 114-1. The transmission light beam modulated by the optical modulator 106-1 is output to the optical amplifier 107-1.

Further, the optical modulator 106-2 modulates the transmission light beam after the phase change by the optical phase shifter 105-2 in accordance with the modulated electrical signal from the RF variable delaying means 114-2. The transmission light beam modulated by the optical modulator 106-2 is output to the optical amplifier 107-2.

Further, the optical modulator 106-n modulates the transmission light beam after the phase change by the optical phase shifter 105-n in accordance with the modulated electrical signal from the RF variable delaying means 114-n. The transmission light beam modulated by the optical modulator 106-n is output to the optical amplifier 107-n.

The optical amplifier 107 is provided for each of the paths.

The optical amplifier 107 amplifies the intensity of the transmission light beam modulated by the corresponding optical modulator 106.

The transmission light beam amplified by the optical amplifier 107 is output to the corresponding optical collimator array 108.

In the example of FIG. 1, the optical amplifier 107-1 amplifies the intensity of the transmission light beam modulated by the optical modulator 106-1. The transmission light beam amplified by the optical amplifier 107-1 is output to the optical collimator array 108-1.

Further, the optical amplifier 107-2 amplifies the intensity of the transmission light beam modulated by the optical modulator 106-2. The transmission light beam amplified by the optical amplifier 107-2 is output to the optical collimator array 108-2.

Further, the optical amplifier 107-n amplifies the intensity of the transmission light beam modulated by the optical modulator 106-n. The transmission light beam amplified by the optical amplifier 107-n is output to the optical collimator array 108-n.

The optical collimator array 108 is provided for each of the paths.

The optical collimator array 108 converts the transmission light beam amplified by the corresponding optical amplifier 107 into a transmission beam that is a parallel beam.

The transmission beam obtained by the optical collimator array 108 is output to the optical beam splitting means 109. Note that, in FIG. 1, reference numeral 14 denotes a transmission beam input to the optical beam splitting means 109.

In the example of FIG. 1, the optical collimator array 108-1 converts the transmission light beam amplified by the optical amplifier 107-1 into a transmission beam that is a parallel beam. The transmission beam obtained by the optical collimator array 108-1 is output to the optical beam splitting means 109.

Further, the optical collimator array 108-2 converts the transmission light beam amplified by the optical amplifier 107-2 into a transmission beam that is a parallel beam. The transmission beam obtained by the optical collimator array 108-2 is output to the optical beam splitting means 109.

Further, the optical collimator array 108-n converts the transmission light beam amplified by the optical amplifier 107-n into a transmission beam that is a parallel beam. The transmission beam obtained by the optical collimator array 108-n is output to the optical beam splitting means 109.

The optical beam splitting means 109 splits some of transmission beams among transmission beams obtained by each optical collimator array 108, and synthesizes the some of the transmission beams with the local beams obtained by the collimating lens 104 to obtain synthesized phase monitoring light.

The remaining transmission beams having passed through the optical beam splitting means 109 are synthesized with each other at a distance to become a synthesized beam and output to the outside. Further, the synthesized phase monitoring light for each of the paths obtained by the optical beam splitting means 109 is output to the corresponding beam condensing means 110. Note that, in FIG. 1, reference numeral 15 denotes a synthesized beam, and reference numeral 16 denotes the synthesized phase monitoring light.

The beam condensing means 110 is provided for each of the paths.

The beam condensing means 110 condenses the corresponding synthesized phase monitoring light obtained by the optical beam splitting means 109.

The synthesized phase monitoring light after being condensed by the beam condensing means 110 is output to the corresponding photoelectric converting means 111.

In the example of FIG. 1, the beam condensing means 110-1 condenses the corresponding synthesized phase monitoring light obtained by the optical beam splitting means 109. The synthesized phase monitoring light after being condensed by the beam condensing means 110-1 is output to the photoelectric converting means 111-1.

Further, the beam condensing means 110-2 condenses the corresponding synthesized phase monitoring light obtained by the optical beam splitting means 109. The synthesized phase monitoring light after being condensed by the beam condensing means 110-2 is output to the photoelectric converting means 111-2.

Further, the beam condensing means 110-n condenses the corresponding synthesized phase monitoring light obtained by the optical beam splitting means 109. The synthesized phase monitoring light after being condensed by the beam condensing means 110-n is output to the photoelectric converting means 111-n.

The photoelectric converting means 111 is provided for each of the paths.

The photoelectric converting means 111 photoelectrically converts the synthesized phase monitoring light after being condensed by the corresponding beam condensing means 110. That is, the photoelectric converting means 111 photoelectrically converts the local beam converted into the same optical path by the optical beam splitting means 109 and the corresponding transmission beam to obtain an electrical signal. This electrical signal is an electrical signal (heterodyne beat signal) equal to the frequency difference between the transmission beam and the local beam.

The electrical signal obtained by the photoelectric converting means 111 is output to the corresponding delay calculating device 113 and the corresponding optical phase synchronization control means 115.

In the example of FIG. 1, the photoelectric converting means 111-1 photoelectrically converts the synthesized phase monitoring light after being condensed by the beam condensing means 110-1 to obtain an electrical signal. The electrical signal obtained by the photoelectric converting means 111-1 is output to the delay calculating device 113-1 and the optical phase synchronization control means 115-1.

Further, the photoelectric converting means 111-2 photoelectrically converts the synthesized phase monitoring light after being condensed by the beam condensing means 110-2 to obtain an electrical signal. The electrical signal obtained by the photoelectric converting means 111-2 is output to the delay calculating device 113-2 and the optical phase synchronization control means 115-2.

Further, the photoelectric converting means 111-n photoelectrically converts the synthesized phase monitoring light after being condensed by the beam condensing means 110-n to obtain an electrical signal. The electrical signal obtained by the photoelectric converting means 111-n is output to the delay calculating device 113-n and the optical phase synchronization control means 115-n.

The signal generating means 112 generates a modulated electrical signal that is a broadband signal. The broadband signal is a signal capable of widening a line width of a signal output from the optical modulator 106 in response to an input signal thereto.

The modulated electrical signal generated by the signal generating means 112 is output to each delay calculating device 113 and each RF variable delaying means 114.

The delay calculating device 113 is provided for each of the paths.

The delay calculating device 113 calculates a delay time difference between the electrical signal obtained by the corresponding photoelectric converting means 111 and the modulated electrical signal generated by the signal generating means 112.

The electrical signal indicating the delay time difference calculated by the delay calculating device 113 is output to the corresponding RF variable delaying means 114.

As a method of calculating the delay time difference by the delay calculating device 113, for example, there is a method of obtaining the delay time difference by using beat signals of each other, or a method of obtaining the delay time difference from a deviation in which a correlation is maximized by taking a correlation while timing of each other is shifted.

In the example of FIG. 1, the delay calculating device 113-1 calculates a delay time difference between the electrical signal obtained by the photoelectric converting means 111-1 and the modulated electrical signal generated by the signal generating means 112. The electrical signal indicating the delay time difference calculated by the delay calculating device 113-1 is output to the RF variable delaying means 114-1.

Further, the delay calculating device 113-2 calculates a delay time difference between the electrical signal obtained by the photoelectric converting means 111-2 and the modulated electrical signal generated by the signal generating means 112. The electrical signal indicating the delay time difference calculated by the delay calculating device 113-2 is output to the RF variable delaying means 114-2.

Further, the delay calculating device 113-n calculates a delay time difference between the electrical signal obtained by the photoelectric converting means 111-n and the modulated electrical signal generated by the signal generating means 112. An electrical signal indicating the delay time difference calculated by the delay calculating device 113-n is output to the RF variable delaying means 114-n.

The RF variable delaying means 114 is provided for each of the paths.

The RF variable delaying means 114 controls the delay time on the basis of the delay time difference calculated by the corresponding delay calculating device 113, and then outputs the modulated electrical signal generated by the signal generating means 112 to the corresponding optical modulator 106.

The RF variable delaying means 114 can be implemented by, for example, a means that mechanically changes the length of the transmission path, a means that switches a plurality of transmission paths having different lengths with a switch, or the like. Examples of a means for mechanically changing the length of the transmission path include a line stretcher.

In the example of FIG. 1, the RF variable delaying means 114-1 controls the delay time on the basis of the delay time difference calculated by the delay calculating device 113-1, and then outputs the modulated electrical signal generated by the signal generating means 112 to the optical modulator 106-1.

Further, the RF variable delaying means 114-2 controls the delay time on the basis of the delay time difference calculated by the delay calculating device 113-2 and then outputs the modulated electrical signal generated by the signal generating means 112 to the optical modulator 106-2.

Furthermore, the RF variable delaying means 114-n controls the delay time on the basis of the delay time difference calculated by the delay calculating device 113-n and then outputs the modulated electrical signal generated by the signal generating means 112 to the optical modulator 106-n.

Note that the signal generating means 112, the plurality of delay calculating devices 113, and the plurality of RF variable delaying means 114 constitute “a modulated electrical signal output means that outputs a modulated electrical signal having a controlled delay time to each of the optical modulators 106 on the basis of the electrical signal obtained by each photoelectric converting means 111”.

The optical phase synchronization control means 115 is provided for each of the paths.

The optical phase synchronization control means 115 detects the phase of the electrical signal obtained by the corresponding photoelectric converting means 111, and outputs a control signal based on the phase to the corresponding optical phase shifter 105. The control signal is a signal for controlling the phase, and is, for example, an electrical signal such as a voltage. At this time, each optical phase synchronization control means 115 generates a control signal in such a manner that the phase difference between the transmission beams becomes constant. For example, the optical phase synchronization control means 115 may generate a control signal by comparing a phase difference between a reference signal source, which is not illustrated, and an electrical signal obtained by the corresponding photoelectric converting means 111, or may generate a control signal by comparing a phase difference between electrical signals output from adjacent photoelectric converting means 111.

In the example of FIG. 1, the optical phase synchronization control means 115-1 detects the phase of the electrical signal obtained by the photoelectric converting means 111-1, and outputs a control signal based on the phase to the corresponding optical phase shifter 105-1.

Further, the optical phase synchronization control means 115-2 detects the phase of the electrical signal obtained by the photoelectric converting means 111-2, and outputs a control signal based on the phase to the corresponding optical phase shifter 105-2.

Furthermore, the optical phase synchronization control means 115-n detects the phase of the electrical signal obtained by the photoelectric converting means 111-n, and outputs a control signal based on the phase to the corresponding optical phase shifter 105-n.

Next, an operation example of the optical beam transmission device 1 according to the first embodiment configured as illustrated in FIG. 1 will be described.

In the optical beam transmission device 1, first, the laser beam output from the laser light source 101 is distributed to (n+1) laser beams by the light distributing means 102.

Then, the frequency of one of the distributed laser beams is shifted as a local light beam by the optical frequency shifting means 103.

Then, the local light beam output from the optical frequency shifting means 103 is converted into a parallel beam by the collimating lens 104 and emitted into space as a local beam.

On the other hand, the transmission phase of each of the n laser beams among the distributed laser beams is controlled by each optical phase shifter 105 in accordance with the control signal from each optical phase synchronization control means 115 as a transmission light beam.

Then, the transmission light beam output from each optical phase shifter 105 is modulated in accordance with the modulated electrical signal from each RF variable delaying means 114 and output by each optical modulator 106.

Then, the intensity of the transmission light beam output from each optical modulator 106 is amplified by each optical amplifier 107, and then the transmission light beam is converted into a parallel beam by each optical collimator array 108, and is emitted into space as a transmission beam.

Thereafter, the transmission beams emitted into the space are synthesized with each other at a distance to become a synthesized beam.

Further, some of the transmission beams and the local beams among the transmission beams emitted into the space are synthesized by the optical beam splitting means 109, and are condensed as synthesized phase monitoring light on each photoelectric converting means 111 via each beam condensing means 110.

Then, the synthesized phase monitoring light is photoelectrically converted by each photoelectric converting means 111, and an electrical signal that is a heterodyne beat signal equal to the frequency difference between the transmission beam and the local beam is output.

Then, each delay calculating device 113 compares the modulated electrical signal output from the signal generating means 112 with the corresponding electrical signal output from each photoelectric converting means 111, and obtains a delay time difference therebetween.

Then, each of the modulated electrical signals output from the signal generating means 112 is delayed by each of the RF variable delaying means 114 depending on the delay time difference obtained by each of the delay calculating devices 113, and becomes a modulated signal to each of the optical modulators 106.

As described above, in the optical beam transmission device 1 according to the first embodiment, the optical modulation and delay control of the modulated electrical signal are performed on all the transmission light beams. Thus, in the optical beam transmission device 1 according to the first embodiment, the transmission beams constituting the synthesized beam have the same modulation waveform at the same timing.

Furthermore, in the optical beam transmission device 1 according to the first embodiment, each optical phase synchronization control means 115 receives the electrical signal output from each photoelectric converting means 111 as input, obtains a control signal to each optical phase shifter 105 from phase information thereof, and controls the phase of the transmission light beam transmitted through each optical phase shifter 105. At this time, the optical phase synchronization control means 115 operates in such a manner that the phase difference between the transmission beams is constant. In the optical beam transmission device 1 according to the first embodiment, the phases of the laser beams are synchronized between the paths by the phase comparison and the control.

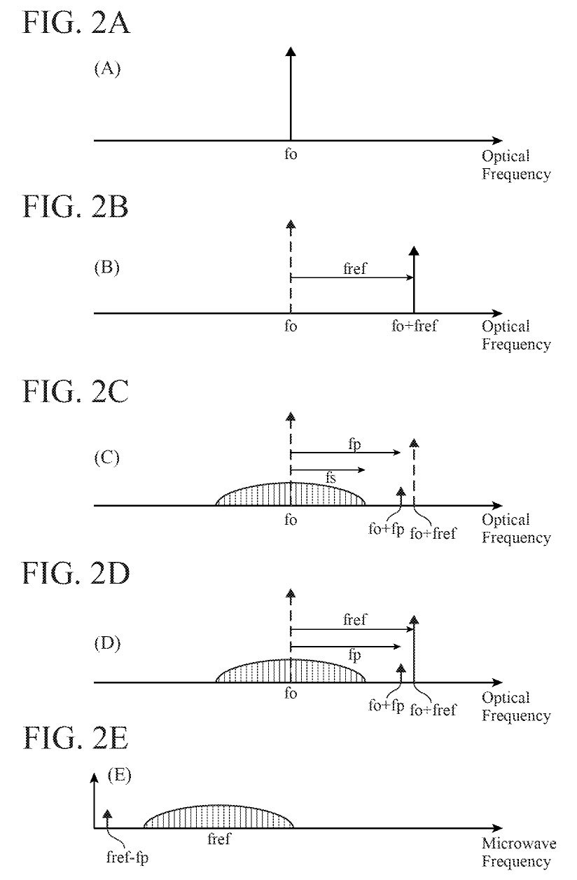

FIG. 2 is a diagram schematically illustrating an example of frequency arrangement (spectrum arrangement) of an optical signal or an electrical signal at each point in FIG. 1. FIG. 2A schematically illustrates an example of the frequency arrangement in portion (A) in FIG. 1, FIG. 2B schematically illustrates an example of the frequency arrangement in portion (B) in FIG. 1, FIG. 2C schematically illustrates an example of the frequency arrangement in portion (C) in FIG. 1, FIG. 2D schematically illustrates an example of the frequency arrangement in portion (D) in FIG. 1, and FIG. 2E schematically illustrates an example of the frequency arrangement in portion (E) in FIG. 1.

FIG. 2A illustrates a frequency of a laser beam output from the laser light source 101. The frequency of this laser beam is fo.

FIG. 2B illustrates a frequency of a local light beam output from the optical frequency shifting means 103. The frequency of the local light beam is fo + fref, and is shifted by fref from the frequency of the laser beam output from the laser light source 101.

Further, FIG. 2C illustrates a frequency of a transmission beam output from the optical collimator array 108. The frequency of the transmission beam is modulated to a wide band (bandwidth 2 fs in FIG. 2C) by the modulated electrical signal from the RF variable delaying means 114. Further, in the transmission beam, a signal having a frequency fo + fp is also superimposed in the vicinity of the frequency (fo + fref) of the local light beam for comparison of optical synchronization. Each of the transmission beams is emitted into space and becomes a synthesized beam coherently synthesized at a distance. Note that, this transmission beam is broadened to a wide band with respect to the frequency (fo) of the laser beam illustrated in FIG. 2A, the occurrence of SBS is suppressed.

Further, FIG. 2D illustrates a frequency of synthesized phase monitoring light output from the optical beam splitting means 109. The frequency of the synthesized phase monitoring light is obtained by synthesizing the frequency of the local light beam illustrated in FIG. 2B and the frequency of the transmission beam illustrated in FIG. 2C.

Further, FIG. 2E illustrates a frequency of an electrical signal output from the photoelectric converting means 111. The frequency of the electrical signal is a difference frequency (beat) component between the signals appearing in FIG. 2D. The calculation of the delay time between the beams is obtained by a correlation calculation or the like with the output from the signal generating means 112 using the broadband signal centered on fref in FIG. 2E.

Note that, in FIG. 2E, the center frequency of the broadband signal is fref, but it goes without saying that this can be converted to any frequency (for example, the center frequency can be set to DC) by using a microwave mixer or the like. Further, the optical phase difference between the paths can be obtained by using a frequency (fref-fp), whereby the optical phases between the paths can be synchronized.

With the above configuration, in the optical beam transmission device 1 according to the first embodiment, since the spectral width of the transmission beam is broadened and the phases of the plurality of transmission beams are synchronized, coherent synthesis with a high brightness beam can be achieved.

As described above, according to the first embodiment, the optical beam transmission device 1 includes: the light distributing means 102 to split a laser beam into one local light beam and a transmission light beam for each of paths; the optical frequency shifting means 103 to shift a frequency of the local light beam obtained by the light distributing means 102; the collimating lens 104 to convert the local light beam after the frequency shift by the optical frequency shifting means 103 into a local beam that is a parallel beam; the optical phase shifter 105 provided for each of the paths to change a phase of a corresponding transmission light beam obtained by the light distributing means 102 in accordance with a control signal; the optical modulator 106 provided for each of the paths to modulate a transmission light beam after a phase change by the corresponding optical phase shifter 105 in accordance with a modulated electrical signal; the optical amplifier 107 provided for each of the paths to amplify intensity of the transmission light beam after modulation by the corresponding optical modulator 106; the optical collimator array 108 provided for each of the paths to convert the transmission light beam after amplification by the corresponding optical amplifier 107 into a transmission beam that is a parallel beam; the optical beam splitting means 109 to split some of transmission beams obtained by the optical collimator array 108 for each of the paths and synthesize the some of the transmission beams with the local beam obtained by the collimating lens 104 to obtain synthesized phase monitoring light; the photoelectric converting means 111 provided for each of the paths to photoelectrically convert corresponding synthesized phase monitoring light obtained by the optical beam splitting means 109 to obtain an electrical signal; the modulated electrical signal output means to output a modulated electrical signal having a controlled delay time to each of the optical modulators 106 for each of the paths on the basis of the electrical signal obtained by the photoelectric converting means 111 for each of the paths; and the optical phase synchronization control means 115 provided for each of the paths to detect a phase of an electrical signal obtained by the corresponding photoelectric converting means 111, and output a control signal based on the phase to the corresponding optical phase shifter 105. Thus, the optical beam transmission device 1 according to the first embodiment can relax manufacturing requirements as compared with the related art.

That is, in the optical beam transmission device 1 according to the first embodiment, the line width of the laser beam is enlarged after the laser beam is distributed to each element. In this manner, in the optical beam transmission device 1 according to the first embodiment, it is not necessary to match the lengths of the fiber paths, and it is possible to relax the requirements for manufacturing as compared with the related art.

Further, in the optical beam transmission device 1 according to the first embodiment, the optical system can be simplified by eliminating a synthesis optical system of a plurality of transmission beams and a local beam, and the array scale can be easily expanded by employing a sub-array configuration.

### Second Embodiment

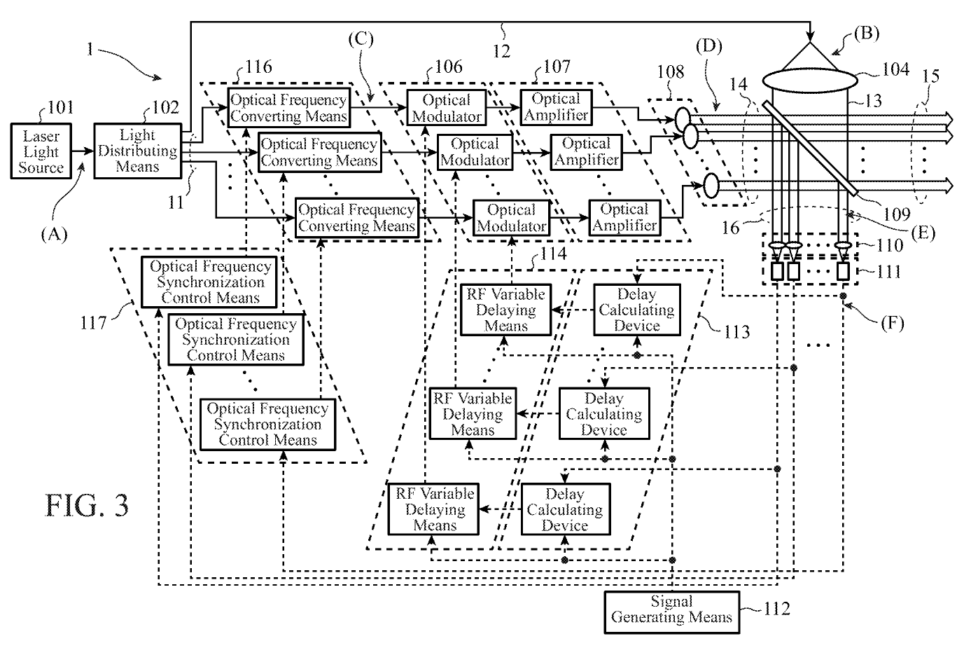

FIG. 3 is a diagram illustrating a configuration example of an optical beam transmission device 1 according to a second embodiment. In the optical beam transmission device 1 according to the second embodiment illustrated in FIG. 3, the optical frequency shifting means 103 is deleted, the plurality of optical phase shifters 105 is changed to a plurality of optical frequency converting means 116, and the plurality of optical phase synchronization control means 115 is changed to a plurality of optical frequency synchronization control means 117, as compared with the optical beam transmission device 1 according to the first embodiment illustrated in FIG. 1. Other configuration examples of the optical beam transmission device 1 according to the second embodiment illustrated in FIG. 3 are similar to those of the optical beam transmission device 1 according to the first embodiment illustrated in FIG. 1, and the same reference numerals are given thereto and only different portions are described.

Although reference numerals are not indicated in FIG. 3, in the optical beam transmission device 1, optical frequency converting means 116-1 to 116-n are provided as the plurality of optical frequency converting means 116, and optical frequency synchronization control means 117-1 to 117-n are provided as the plurality of optical frequency synchronization control means 117.

Note that the local light beam obtained by the light distributing means 102 in the second embodiment is output to the collimating lens 104. Further, the transmission light beam for each of the paths obtained by the light distributing means 102 in the second embodiment is output to the corresponding optical frequency converting means 116.

Further, the collimating lens 104 in the second embodiment converts the local light beam obtained by the light distributing means 102 into a local beam that is a parallel beam.

The optical frequency converting means 116 is provided for each of the paths.

The optical frequency converting means 116 transitions the frequency of the corresponding transmission light beam obtained by the light distributing means 102 in accordance with a control signal from the corresponding optical frequency synchronization control means 117.

The transmission light beam after frequency transition by the optical frequency converting means 116 is output to the corresponding optical modulator 106.

In the example of FIG. 3, the optical frequency converting means 116-1 transitions the frequency of the corresponding transmission light beam obtained by the light distributing means 102 in accordance with the control signal from the optical frequency synchronization control means 117-1. The transmission light beam after frequency transition by the optical frequency converting means 116-1 is output to the optical modulator 106-1.

Further, the optical frequency converting means 116-2 transitions the frequency of the corresponding transmission light beam obtained by the light distributing means 102 in accordance with the control signal from the optical frequency synchronization control means 117-2. The transmission light beam after frequency transition by the optical frequency converting means 116-2 is output to the optical modulator 106-2.

Further, the optical frequency converting means 116-n transitions the frequency of the corresponding transmission light beam obtained by the light distributing means 102 in accordance with the control signal from the optical frequency synchronization control means 117-n. The transmission light beam after frequency transition by the optical frequency converting means 116-n is output to the optical modulator 106-n.

Further, the optical modulator 106 in the second embodiment modulates the transmission light beam after frequency transition by the corresponding optical frequency converting means 116 in accordance with the modulated electrical signal from the corresponding RF variable delaying means 114.

Further, the electrical signal obtained by the photoelectric converting means 111 in the second embodiment is output to the corresponding delay calculating device 113 and the corresponding optical frequency synchronization control means 117.

The optical frequency synchronization control means 117 is provided for each of the paths.

The optical frequency synchronization control means 117 detects a frequency variation of the electrical signal obtained by the corresponding photoelectric converting means 111, and outputs a control signal based on the frequency variation to the corresponding optical frequency converting means 116. The control signal is a signal for controlling the frequency, and is, for example, a high frequency signal. At this time, each optical frequency synchronization control means 117 generates a control signal in such a manner that the frequency variation difference between the transmission beams becomes constant. For example, the optical frequency synchronization control means 117 may generate a control signal by comparing a frequency variation difference between a reference signal source, which is not illustrated, and an electrical signal obtained by the corresponding photoelectric converting means 111, or may generate a control signal by comparing a frequency variation difference between electrical signals output from adjacent photoelectric converting means 111.

In the example of FIG. 3, the optical frequency synchronization control means 117-1 detects a frequency variation of the electrical signal obtained by the photoelectric converting means 111-1, and outputs a control signal based on the frequency variation to the optical frequency converting means 116-1.

Further, the optical frequency synchronization control means 117-2 detects a frequency variation of the electrical signal obtained by the photoelectric converting means 111-2, and outputs a control signal based on the frequency variation to the optical frequency converting means 116-2.

Further, the optical frequency synchronization control means 117-n detects a frequency variation of the electrical signal obtained by the photoelectric converting means 111-n, and outputs a control signal based on the frequency variation to the optical frequency converting means 116-n.

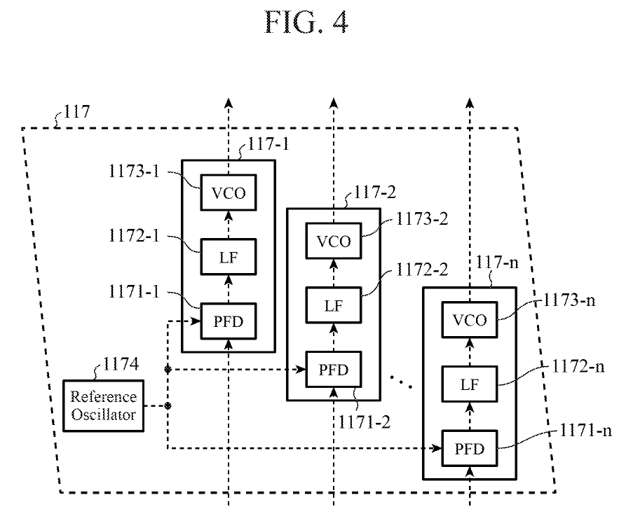

As illustrated in FIG. 4, for example, each optical frequency synchronization control means 117 includes a phase frequency detector (PFD) 1171, a loop filter (LF) 1172, and a voltage controlled oscillator (VCO) 1173. Further, a reference oscillator 1174 is provided for common use across the entire optical frequency synchronization control means 117. Note that the configuration illustrated in FIG. 4 is a representative configuration.

In FIG. 4, PFDs 1171-1 to 1171-n are provided as each PFD 1171, LFs 1172-1 to 1172-n are provided as each LF 1172, and VCOs 1173-1 to 1173-n are provided as each VCO 1173.

The PFD 1171 compares the frequency of the electrical signal obtained by the corresponding photoelectric converting means 111 with the frequency of the signal from the external reference oscillator 1174 to obtain an error signal.

The error signal obtained by the PFD 1171 is output to the corresponding LF 1172.

In the example of FIG. 4, the PFD 1171-1 compares the frequency of the electrical signal obtained by the photoelectric converting means 111-1 with the frequency of the signal from the external reference oscillator 1174 to obtain an error signal. The error signal obtained by the PFD 1171-1 is output to the LF 1172-1.

Further, the PFD 1171-2 compares the frequency of the electrical signal obtained by the photoelectric converting means 111-2 with the frequency of the signal from the external reference oscillator 1174 to obtain an error signal. The error signal obtained by the PFD 1171-2 is output to the LF 1172-2.

Further, the PFD 1171-n compares the frequency of the electrical signal obtained by the photoelectric converting means 111-n with the frequency of the signal from the external reference oscillator 1174 to obtain an error signal. The error signal obtained by the PFD 1171-n is output to the LF 1172-n.

In order to stabilize a phase-locked loop, the LF 1172 smooths the error signal obtained by the corresponding PFD 1171 to obtain a DC signal.

The DC signal obtained by the LF 1172 is output to the corresponding VCO 1173.

In the example of FIG. 4, the LF 1172-1 smooths the error signal obtained by the PFD 1171-1 to obtain a DC signal. The DC signal obtained by the LF 1172-1 is output to the VCO 1173-1.

The LF 1172-2 smooths the error signal obtained by the PFD 1171-2 to obtain a DC signal. The DC signal obtained by the LF 1172-2 is output to the VCO 1173-2.

Further, the LF 1172-n smooths the error signal obtained by the PFD 1171-n to obtain a DC signal. The DC signal obtained by the LF 1172-n is output to the VCO 1173-n.

The VCO 1173 generates a control signal on the basis of the DC signal obtained by the corresponding LF 1172.

The control signal generated by the VCO 1173 is output to the corresponding optical frequency converting means 116.

In the example of FIG. 4, the VCO 1173-1 generates a control signal on the basis of the DC signal obtained by the LF 1172-1. The control signal generated by the VCO 1173-1 is output to the optical frequency converting means 116-1.

Further, the VCO 1173-2 generates a control signal on the basis of the DC signal obtained by the LF 1172-2. The control signal generated by the VCO 1173-2 is output to the optical frequency converting means 116-2.

Further, the VCO 1173-n generates a control signal on the basis of the DC signal obtained by the LF 1172-n. The control signal generated by the VCO 1173-n is output to the optical frequency converting means 116-n.

Next, an operation example of the optical beam transmission device 1 according to the second embodiment configured as illustrated in FIG. 3 will be described.

In the optical beam transmission device 1, first, the laser beam output from the laser light source 101 is distributed to (n+1) laser beams by the light distributing means 102.

Then, the local light beam, which is one of the distributed laser beams, is converted into a parallel beam by the collimating lens 104 without passing through the optical frequency shifting means 103, and is emitted into space as a local beam.

On the other hand, the frequency of each of the n laser beams among the distributed laser beams is controlled by each optical frequency converting means 116 in accordance with the control signal from each optical frequency synchronization control means 117 as a transmission light beam.

Then, the transmission light beam output from each optical frequency converting means 116 is modulated in accordance with the modulated electrical signal from each RF variable delaying means 114 and output by each optical modulator 106.

Then, the intensity of the transmission light beam output from each optical modulator 106 is amplified by each optical amplifier 107, and then the transmission light beam is converted into a parallel beam by each optical collimator array 108, and is emitted into space as a transmission beam.

Thereafter, the transmission beams emitted into the space are synthesized with each other at a distance to become a synthesized beam.

Further, some of the transmission beams and the local beams among the transmission beams emitted into the space are synthesized by the optical beam splitting means 109, and are condensed as synthesized phase monitoring light on each photoelectric converting means 111 via each beam condensing means 110.

Then, the synthesized phase monitoring light is photoelectrically converted by each photoelectric converting means 111, and an electrical signal that is a heterodyne beat signal equal to the frequency difference between the transmission beam and the local beam is output.

Then, each delay calculating device 113 compares the modulated electrical signal output from the signal generating means 112 with the corresponding electrical signal output from each photoelectric converting means 111, and obtains a delay time difference therebetween.

Then, each of the modulated electrical signals output from the signal generating means 112 is delayed by each of the RF variable delaying means 114 depending on the delay time difference obtained by each of the delay calculating devices 113, and becomes a modulated signal to each of the optical modulators 106.

As described above, in the optical beam transmission device 1 according to the second embodiment, the optical modulation and delay control of the modulated electrical signal are performed on all the transmission light beams. Thus, in the optical beam transmission device 1 according to the second embodiment, the transmission beams constituting the synthesized beam have the same modulation waveform at the same timing.

Furthermore, in the optical beam transmission device 1 according to the second embodiment, each optical frequency synchronization control means 117 receives the electrical signal output from each photoelectric converting means 111 as input, obtains a control signal to each optical frequency converting means 116 from frequency variation information thereof, and controls the frequency of the transmission light beam transmitted through each optical frequency converting means 116. At this time, the optical frequency synchronization control means 117 operates in such a manner that the frequency variation difference between the transmission beams is constant. In the optical beam transmission device 1 according to the second embodiment, the phases of the laser beams are synchronized between the paths by the frequency variation comparison and the control.

That is, in general, there is a relationship between the phase frequency of a wave in such a manner that the frequency is obtained by differentiating the phase. Therefore, the phase of the transmission light beam can be controlled by controlling the instantaneous frequency.

Note that the transmission signal, in either optical or electrical state, is looped through the optical frequency converting means 116, the optical modulator 106, the optical amplifier 107, the optical collimator array 108, the optical beam splitting means 109, the beam condensing means 110, the photoelectric converting means 111, the optical frequency synchronization control means 117, and the optical frequency converting means 116 and the transmission signal transmitted in the loop is stabilized by the optical frequency synchronization control means 117.

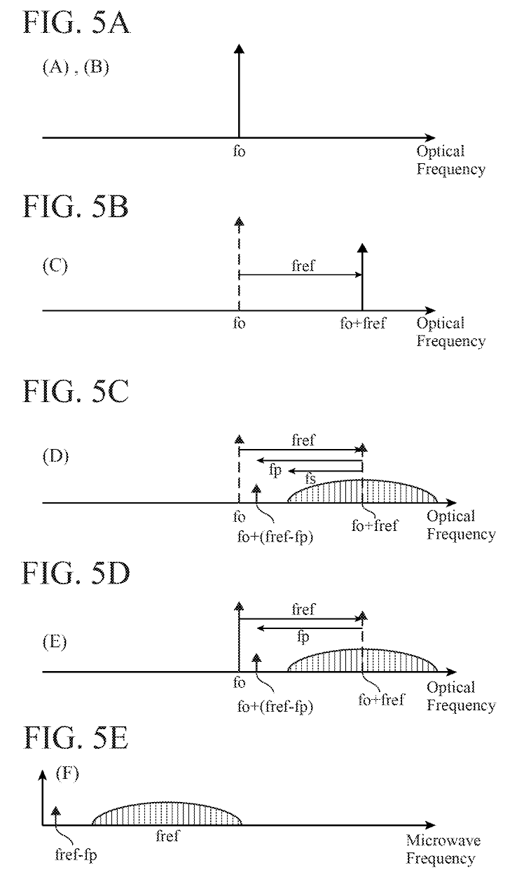

FIG. 5 is a diagram schematically illustrating an example of frequency arrangement (spectrum arrangement) of an optical signal or an electrical signal at each point in FIG. 3. FIG. 5A schematically illustrates an example of frequency arrangement in portions (A) and (B) in FIG. 3, FIG. 5B schematically illustrates an example of frequency arrangement in portion (C) in FIG. 3, FIG. 5C schematically illustrates an example of frequency arrangement in portion (D) in FIG. 3, FIG. 5D schematically illustrates an example of frequency arrangement in portion (E) in FIG. 3, and FIG. 5E schematically illustrates an example of frequency arrangement in portion (F) in FIG. 3.

FIG. 5A illustrates a frequency of a laser beam output from the laser light source 101 and a frequency of a local light beam input to the collimating lens 104. The frequency of this laser beam is fo. Further, the frequency of the local light beam is the same as the frequency of the laser beam output from the laser light source 101, and is fo. Further, FIG. 5B illustrates a frequency of the transmission light beam output from the optical frequency converting means 116. The frequency of the transmission light beam is fo + fref, and is shifted by fref from the frequency of the laser beam output from the laser light source 101.

Further, FIG. 5C illustrates a frequency of the transmission beam output from the optical collimator array 108. The frequency of the transmission beam is modulated to a wide band (bandwidth 2 fs in FIG. 5C) by the modulated electrical signal from the RF variable delaying means 114. Further, in this transmission beam, since fref is also superimposed and modulated in addition to the broadband signal, a signal of fo + (frep - fp) is also superimposed. Each of the transmission beams is emitted into space and becomes a synthesized beam coherently synthesized at a distance. Note that, this transmission beam is broadened to a wide band with respect to the frequency (fo) of the laser beam illustrated in FIG. 5A, the occurrence of SBS is suppressed.

Further, FIG. 5D illustrates a frequency of the synthesized phase monitoring light output from the optical beam splitting means 109. The frequency of the synthesized phase monitoring light is obtained by synthesizing the frequency of the local light beam illustrated in FIG. 5A and the frequency of the transmission beam illustrated in FIG. 5C.

Further, FIG. 5E illustrates a frequency of an electrical signal output from the photoelectric converting means 111. The frequency of the electrical signal is a difference frequency (beat) component between the signals appearing in FIG. 5D. The calculation of the delay time between the beams is obtained by a correlation calculation or the like with the output from the signal generating means 112 using the broadband signal centered on fref in FIG. 5E.

Note that, in FIG. 5E, the center frequency of the broadband signal is fref, but it goes without saying that this can be converted to any frequency (for example, the center frequency can be set to DC) by using a microwave mixer or the like. Further, the optical phase difference between the paths can be obtained by using a frequency (fref-fp), whereby the optical phases between the paths can be synchronized.

With the above configuration, in the optical beam transmission device 1 according to the second embodiment, since the spectral width of the transmission beam is broadened and the phases of the plurality of transmission beams are synchronized, coherent synthesis by a beam with high brightness can be performed.

Furthermore, in the optical beam transmission device 1 according to the second embodiment, since the phase control between the paths is performed by the instantaneous frequency control using the optical frequency converting means 116, the application range of the phase control can be expanded as compared with the optical beam transmission device 1 according to the first embodiment.

As described above, according to the second embodiment, the optical beam transmission device 1 includes: the light distributing means 102 to split a laser beam into one local light beam and a transmission light beam for each of paths; the collimating lens 104 to convert the local light beam obtained by the light distributing means 102 into a local beam that is a parallel beam; the optical frequency converting means 116 provided for each of the paths to transition a frequency of a corresponding transmission light beam obtained by the light distributing means 102 in accordance with a control signal; the optical modulator 106 provided for each of the paths to modulate a transmission light beam after a frequency transition by the corresponding optical frequency converting means 116 in accordance with a modulated electrical signal; the optical amplifier 107 provided for each of the paths to amplify intensity of the transmission light beam after modulation by the corresponding optical modulator 106; the optical collimator array 108 provided for each of the paths to convert the transmission light beam after amplification by the corresponding optical amplifier 107 into a transmission beam that is a parallel beam; the optical beam splitting means 109 to split some of transmission beams obtained by the optical collimator array 108 for each of the paths and synthesize the some of the transmission beams with the local beam obtained by the collimating lens 104 to obtain synthesized phase monitoring light; the photoelectric converting means 111 provided for each of the paths to photoelectrically convert corresponding synthesized phase monitoring light obtained by the optical beam splitting means 109 to obtain an electrical signal; the modulated electrical signal output means to output a modulated electrical signal having a controlled delay time to each of the optical modulators 106 for each of the paths on the basis of the electrical signal obtained by the photoelectric converting means 111 for each of the paths; and the optical frequency synchronization control means 117 provided for each of the paths to detect a frequency variation of an electrical signal obtained by the corresponding photoelectric converting means 111, and output a control signal based on the frequency variation to the corresponding optical frequency converting means 116. Thus, the optical beam transmission device 1 according to the second embodiment can expand the application range of the phase control in addition to the effects of the optical beam transmission device 1 according to the first embodiment.

### Third Embodiment

In a third embodiment, another configuration example of the modulated electrical signal output means will be described.

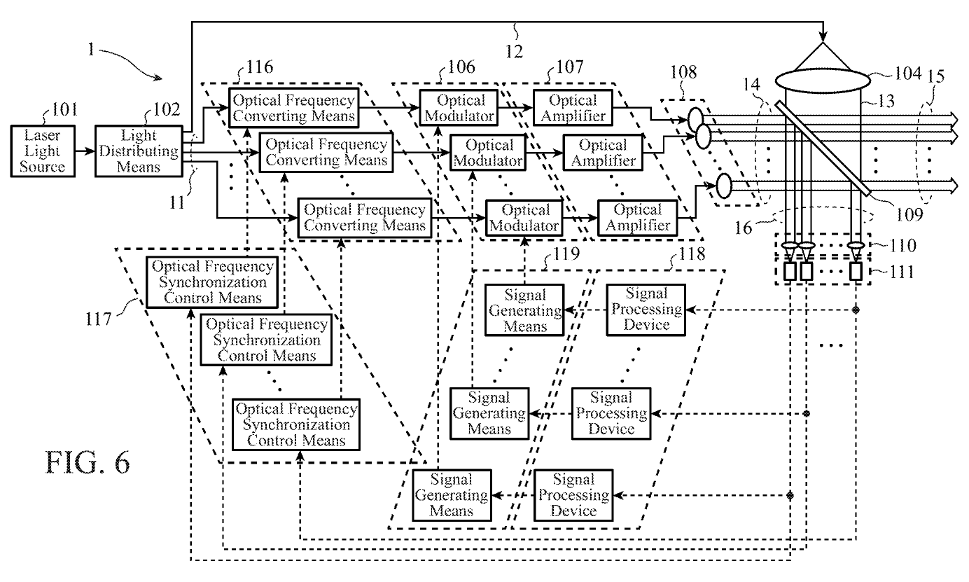

FIG. 6 is a diagram illustrating a configuration example of an optical beam transmission device 1 according to the third embodiment. In the optical beam transmission device 1 according to the third embodiment illustrated in FIG. 6, the signal generating means 112, the plurality of delay calculating devices 113, and the plurality of RF variable delaying means 114 are changed to a plurality of signal processing devices 118 and a plurality of signal generating means 119 as compared with the optical beam transmission device 1 according to the second embodiment illustrated in FIG. 3. Other configuration examples of the optical beam transmission device 1 according to the third embodiment illustrated in FIG. 6 are similar to those of the optical beam transmission device 1 according to the second embodiment illustrated in FIG. 3, and the same reference numerals are given thereto and only different portions are described.

Further, although reference numerals are not indicated in FIG. 6, in the optical beam transmission device 1, signal processing devices 118-1 to 118-n are provided as the plurality of signal processing devices 118, and signal generating means 119-1 to 119-n are provided as the plurality of signal generating means 119.

Note that the electrical signal obtained by the photoelectric converting means 111 in the third embodiment is output to the corresponding signal processing device 118 and the corresponding optical frequency synchronization control means 117.

The signal processing device 118 is provided for each of the paths.

The signal processing device 118 calculates a delay time of the electrical signal on the basis of the electrical signal obtained by the corresponding photoelectric converting means 111, and generates a timing signal based on the delay time.

The timing signal generated by the signal processing device 118 is output to the corresponding signal generating means 119.

In the example of FIG. 6, the signal processing device 118-1 calculates a delay time of the electrical signal on the basis of the electrical signal obtained by the photoelectric converting means 111-1, and generates a timing signal based on the delay time. The timing signal generated by the signal processing device 118-1 is output to the signal generating means 119-1.

Further, the signal processing device 118-2 calculates a delay time of the electrical signal on the basis of the electrical signal obtained by the photoelectric converting means 111-2, and generates a timing signal based on the delay time. The timing signal generated by the signal processing device 118-2 is output to the signal generating means 119-2.

Further, the signal processing device 118-n calculates a delay time of the electrical signal on the basis of the electrical signal obtained by the photoelectric converting means 111-n, and generates a timing signal based on the delay time. The timing signal generated by the signal processing device 118-n is output to the signal generating means 119-n.

The signal generating means 119 is provided for each of the paths.

The signal generating means 119 outputs the modulated electrical signal to the corresponding optical modulator 106 in accordance with the timing signal generated by the corresponding signal processing device 118. The modulated electrical signal used in each signal generating means 119 is a broadband signal having a common waveform. The broadband signal is a signal capable of widening a line width of a signal output from the optical modulator 106 in response to an input signal thereto.

For example, the signal generating means 119 can generate a signal at any timing by outputting digital waveform data stored in an internal memory at a timing instructed from the signal processing device 118 via digital/analog conversion (D/A).

In the example of FIG. 6, the signal generating means 119-1 outputs the modulated electrical signal to the optical modulator 106-1 in accordance with the timing signal generated by the signal processing device 118-1.

Further, the signal generating means 119-2 outputs the modulated electrical signal to the optical modulator 106-2 in accordance with the timing signal generated by the signal processing device 118-2.

Further, the signal generating means 119-n outputs the modulated electrical signal to the optical modulator 106-n in accordance with the timing signal generated by the signal processing device 118-n.

Further, the optical modulator 106 in the third embodiment modulates the transmission light beam after frequency transition by the corresponding optical frequency converting means 116 in accordance with the modulated electrical signal output by the corresponding signal generating means 119.

Note that the plurality of signal processing devices 118 and the plurality of signal generating means 119 constitute “a modulated electrical signal output means that outputs a modulated electrical signal having a controlled delay time to each of the optical modulators 106 on the basis of the electrical signal obtained by each photoelectric converting means 111”.

Next, an operation example of the optical beam transmission device 1 according to the third embodiment configured as illustrated in FIG. 6 will be described.

In the optical beam transmission device 1, first, the laser beam output from the laser light source 101 is distributed to (n+1) laser beams by the light distributing means 102.

Then, a local light beam that is one of the distributed laser beams is converted into a parallel beam by the collimating lens 104 and emitted into space as a local beam.

On the other hand, the frequency of each of the n laser beams among the distributed laser beams is controlled by each optical frequency converting means 116 in accordance with the control signal from each optical frequency synchronization control means 117 as a transmission light beam.

Then, the transmission light beam output from each optical frequency converting means 116 is modulated in accordance with the modulated electrical signal from each signal generating means 119 and output by each optical modulator 106.

Then, the intensity of the transmission light beam output from each optical modulator 106 is amplified by each optical amplifier 107, and then the transmission light beam is converted into a parallel beam by each optical collimator array 108, and is emitted into space as a transmission beam.

Thereafter, the transmission beams emitted into the space are synthesized with each other at a distance to become a synthesized beam.

Further, some of the transmission beams and the local beams among the transmission beams emitted into the space are synthesized by the optical beam splitting means 109, and are condensed as synthesized phase monitoring light on each photoelectric converting means 111 via each beam condensing means 110.

Then, the synthesized phase monitoring light is photoelectrically converted by each photoelectric converting means 111, and an electrical signal that is a heterodyne beat signal equal to the frequency difference between the transmission beam and the local beam is output.

Here, in the third embodiment, the plurality of signal processing devices 118 and the plurality of signal generating means 119 are provided instead of the signal generating means 112, the plurality of RF variable delaying means 114, and the plurality of delay calculating devices 113, as compared with the second embodiment.

Then, in each signal processing device 118, the electrical signal output from each photoelectric converting means 111 is input to calculate the delay time for each of the paths. Furthermore, each signal processing device 118 generates a timing signal indicating a timing at which each signal generating means 119 outputs a signal depending on the calculated delay time.

Then, each signal generating means 119 outputs a modulated electrical signal, which is a broadband signal having the same waveform, to each optical modulator 106 in accordance with the timing signal from each signal processing device 118.

As described above, in the optical beam transmission device 1 according to the third embodiment, the timing of waveform output can be controlled by digital signal processing. Thus, in the optical beam transmission device 1 according to the third embodiment, the RF variable delaying means 114 are unnecessary, and it is possible to relax restrictions on the setting range of the delay time and the setting resolution, and the like.

Note that, in FIG. 6, the signal processing device 118 and the signal generating means 119 are provided for each of the paths, but it goes without saying that these may be provided in a single device, and it goes without saying that these are synchronized with each other in order to adjust the timing between the signal processing devices 118.

Further, FIG. 6 illustrates a case where the signal generating means 112, the plurality of delay calculating devices 113, and the plurality of RF variable delaying means 114 are changed to the plurality of signal processing devices 118 and the plurality of signal generating means 119 as compared with the optical beam transmission device 1 according to the second embodiment.

However, it is not limited to this, and the signal generating means 112, the plurality of delay calculating devices 113, and the plurality of RF variable delaying means 114 may be changed to the plurality of signal processing devices 118 and the plurality of signal generating means 119 as compared with the optical beam transmission device 1 according to the first embodiment, and effects similar to those described above can be obtained.

As described above, according to the third embodiment, the modulated electrical signal output means includes: the signal processing device 118 provided for each of the paths to calculate a delay time of an electrical signal on the basis of the electrical signal obtained by the corresponding photoelectric converting means 111, and generate a timing signal based on the delay time, and the signal generating means 119 provided for each of the paths to output modulated electrical signals having a waveform common to each other to the corresponding optical modulator 106 in accordance with the timing signal generated by the corresponding signal processing device 118. Thus, the optical beam transmission device 1 according to the third embodiment does not need the RF variable delaying means 114 as compared with the optical beam transmission devices 1 according to the first and second embodiments, and it is possible to relax restrictions on the setting range of the delay time and the setting resolution, and the like.

### Fourth Embodiment

In a fourth embodiment, another configuration example of the modulated electrical signal output means will be described.

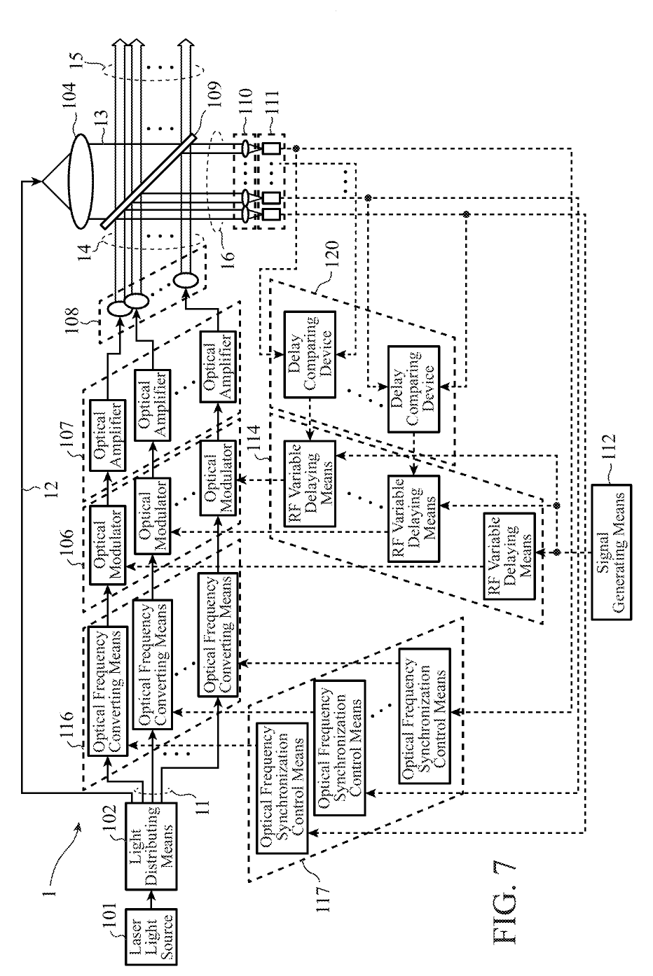

FIG. 7 is a diagram illustrating a configuration example of an optical beam transmission device 1 according to the fourth embodiment. In the optical beam transmission device 1 according to the fourth embodiment illustrated in FIG. 7, the plurality of delay calculating devices 113 is changed to a plurality of delay comparing devices 120 as compared with the optical beam transmission device 1 according to the second embodiment illustrated in FIG. 3. Other configuration examples of the optical beam transmission device 1 according to the fourth embodiment illustrated in FIG. 7 are similar to those of the optical beam transmission device 1 according to the second embodiment illustrated in FIG. 3, and the same reference numerals are given thereto and only different portions are described.

Although reference numerals are not indicated in FIG. 7, in the optical beam transmission device 1, delay comparing devices 120-2 to 120-n are provided as the plurality of delay comparing devices 120.

Note that the electrical signal obtained by the photoelectric converting means 111 in the fourth embodiment is output to the corresponding delay comparing device 120 and the corresponding optical frequency synchronization control means 117.

Further, the modulated electrical signal generated by the signal generating means 112 in the fourth embodiment is output to each RF variable delaying means 114.

The delay comparing device 120 is provided between each pair of the paths.

The delay comparing device 120 calculates, on the basis of electrical signals obtained by the corresponding two adjacent photoelectric converting means 111, a delay time difference between the electrical signals.

The electrical signal indicating the delay time difference calculated by the delay comparing device 120 is output to the corresponding RF variable delaying means 114.

In the example of FIG. 7, the delay comparing device 120-2 calculates, on the basis of each electrical signal obtained by the photoelectric converting means 111-1 and 111-2, a delay time difference between the electrical signals. The electrical signal indicating the delay time difference calculated by the delay comparing device 120-2 is output to the RF variable delaying means 114-2.

Further, the delay comparing device 120-n calculates, on the basis of each electrical signal obtained by the photoelectric converting means 111-n-1 and 111-n, a delay time difference between the electrical signals. The electrical signal indicating the delay time difference calculated by the delay comparing device 120-n is output to the RF variable delaying means 114-n.

Further, the RF variable delaying means 114 in the fourth embodiment controls the delay time on the basis of the delay time difference calculated by the corresponding delay comparing device 120, and then outputs the modulated electrical signal generated by the signal generating means 112 to the corresponding optical modulator 106.

Note that the RF variable delaying means 114 (the RF variable delaying means 114-1 in FIG. 7) provided in the reference path outputs the modulated electrical signal generated by the signal generating means 112 to the corresponding optical modulator 106 without controlling the delay time.

Note that the signal generating means 112, the plurality of delay comparing devices 120, and the plurality of RF variable delaying means 114 constitute “a modulated electrical signal output means that outputs a modulated electrical signal having a controlled delay time to each of the optical modulators 106 on the basis of the electrical signal obtained by each photoelectric converting means 111”.

Next, an operation example of the optical beam transmission device 1 according to the fourth embodiment configured as illustrated in FIG. 7 will be described.

In the optical beam transmission device 1, first, the laser beam output from the laser light source 101 is distributed to (n+1) laser beams by the light distributing means 102.

Then, a local light beam that is one of the distributed laser beams is converted into a parallel beam by the collimating lens 104 and emitted into space as a local beam.

On the other hand, the frequency of each of the n laser beams among the distributed laser beams is controlled by each optical frequency converting means 116 in accordance with the control signal from each optical frequency synchronization control means 117 as a transmission light beam.

Then, the transmission light beam output from each optical frequency converting means 116 is modulated in accordance with the modulated electrical signal from each RF variable delaying means 114 and output by each optical modulator 106.

Then, the intensity of the transmission light beam output from each optical modulator 106 is amplified by each optical amplifier 107, and then the transmission light beam is converted into a parallel beam by each optical collimator array 108, and is emitted into space as a transmission beam.

Thereafter, the transmission beams emitted into the space are synthesized with each other at a distance to become a synthesized beam.

Further, some of the transmission beams and the local beams among the transmission beams emitted into the space are synthesized by the optical beam splitting means 109, and are condensed as synthesized phase monitoring light on each photoelectric converting means 111 via each beam condensing means 110.

Then, the synthesized phase monitoring light is photoelectrically converted by each photoelectric converting means 111, and an electrical signal that is a heterodyne beat signal equal to the frequency difference between the transmission beam and the local beam is output.

Here, in the fourth embodiment, the plurality of delay comparing devices 120 is provided instead of the plurality of delay calculating devices 113 in the second embodiment.

Then, each delay comparing device 120 compares the two electrical signals output from each photoelectric converting means 111 to obtain a delay time difference between the paths. For example, in FIG. 7, each delay comparing device 120 sequentially obtains the delay time difference in such a manner that the delay comparing device 120-2 obtains the delay time difference of the electrical signal output from the photoelectric converting means 111-2 on the basis of the electrical signal output from the photoelectric converting means 111-1, and the delay comparing device 120-3 obtains the delay time difference of the electrical signal output from the photoelectric converting means 111-3 on the basis of the electrical signal output from the photoelectric converting means 111-2.

Then, the modulated electrical signal output from the signal generating means 112 is delayed by each RF variable delaying means 114 depending on the delay time difference obtained by each delay comparing device 120, and becomes a modulated signal to each optical modulator 106. For example, in FIG. 7, the RF variable delaying means 114-1 outputs the modulated electrical signal as it is to the optical modulator 106-1, the RF variable delaying means 114-2 outputs the modulated electrical signal to the optical modulator 106-2 on the basis of the delay time difference obtained by the delay comparing device 120-2, and the RF variable delaying means 114-3 outputs the modulated electrical signal to the optical modulator 106-3 on the basis of the delay time difference obtained by the delay comparing device 120-3.

As described above, in the optical beam transmission device 1 according to the fourth embodiment, each delay comparing device 120 compares the electrical signals to obtain the delay time difference. Here, since the paths are installed adjacent to each other, the amount of variation in temperature or the like becomes close. Therefore, it is expected that a delay time difference between adjacent paths is also reduced. Therefore, in the optical beam transmission device 1 according to the fourth embodiment, it is possible to reduce the dynamic range of delay control.

Further, FIG. 7 illustrates a case where the plurality of delay calculating devices 113 is changed to the plurality of delay comparing devices 120 as compared with the optical beam transmission device 1 according to the second embodiment.

However, it is not limited thereto, and the plurality of delay calculating devices 113 may be changed to the plurality of delay comparing devices 120 with respect to the optical beam transmission device 1 according to the first embodiment, and the same effect as described above can be obtained.

As described above, according to the fourth embodiment, the modulated electrical signal output means includes: the signal generating means 112 to generate a modulated electrical signal; the delay comparing device 120 provided between each pair of the paths to calculate, on the basis of electrical signals obtained by the two corresponding adjacent photoelectric converting means 111, a delay time difference between the electrical signals; and the RF variable delaying means 114 provided for each of the paths to control a delay time on the basis of the delay time difference calculated by the corresponding delay comparing device 120, and output the modulated electrical signal generated by the signal generating means 112 to the corresponding optical modulator 106. Thus, the optical beam transmission device 1 according to the fourth embodiment can reduce the dynamic range of the delay control as compared with the optical beam transmission device 1 according to the first to third embodiments.

Note that, in the first to fourth embodiments described above, the modulated electrical signal output from the signal generating means 112 may be, for example, a sine wave, a rectangular wave, or a triangular wave.

Further, in the above-described first to fourth embodiments, the modulated electrical signal output from the signal generating means 112 may be a pseudorandom signal. Even in this case, the optical beam transmission device 1 can obtain each delay time difference by performing delay control and cross-correlation calculation between the signal source and the transmission signal.

In the first to fourth embodiments, the modulated electrical signal output from the signal generating means 112 may be a signal modulated for communication. Also in this case, the optical beam transmission device 1 can obtain each delay time difference by performing delay control and cross-correlation calculation between the signal source and the transmission signal.

Further, in the above-described first to fourth embodiments, the case where the optical beam transmission device 1 obtains the delay time difference from the correlation between the signal source and the transmission signal has been described.

However, it is not limited thereto, and for example, the optical beam transmission device 1 may superimpose a short pulse signal on a band that can be separated from any of the above frequencies separately from the phase detection signal (frequency fp), and obtain the delay time difference from the time until the pulse signal is detected.

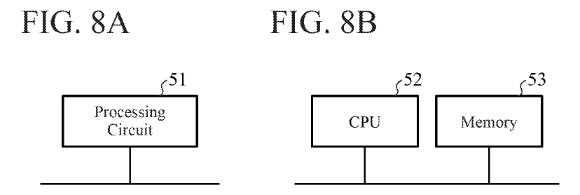

Finally, a hardware configuration example of the optical beam transmission device 1 according to the first to fourth embodiments will be described with reference to FIG. 8. Note that a hardware configuration example of the optical beam transmission device 1 according to the first embodiment will be described below, but the same applies to a hardware configuration example of the optical beam transmission device 1 according to the second to fourth embodiments.

The functions of the delay calculating device 113 and the optical phase synchronization control means 115 in the optical beam transmission device 1 are implemented by a processing circuit 51. The processing circuit 51 may be dedicated hardware as illustrated in FIG. 8A, or may be a central processing unit (CPU, which may also be referred to as a central processing device, a processing device, an arithmetic device, a microprocessor, a microcomputer, a processor, or a digital signal processor (DSP)) 52 that executes a program stored in a memory 53 as illustrated in FIG. 8B.

In a case where the processing circuit 51 is dedicated hardware, the processing circuit 51 corresponds to, for example, a single circuit, a composite circuit, a programmed processor, a parallel programmed processor, an application specific integrated circuit (ASIC), a field-programmable gate array (FPGA), or a combination thereof. The functions of each unit of the delay calculating device 113 and the optical phase synchronization control means 115 may be implemented by the processing circuit 51, or the functions of the each unit may be collectively implemented by the processing circuit 51.

In a case where the processing circuit 51 is the CPU 52, the functions of the delay calculation device 113 and the optical phase synchronization control means 115 are implemented by software, firmware, or a combination of software and firmware. The software and the firmware are described as programs and stored in the memory 53. The processing circuit 51 implements the functions of each unit by reading and executing the program stored in the memory 53. That is, the optical beam transmission device 1 includes a memory for storing a program that results in execution of the processing described above, for example, when executed by the processing circuit 51. It can also be said that these programs cause a computer to execute the procedure and method performed by the delay calculating device 113 and the optical phase synchronization control means 115. Examples of the memory 53 include a nonvolatile or volatile semiconductor memory such as a random access memory (RAM), a read only memory (ROM), a flash memory, an erasable programmable ROM (EPROM), or an electrically EPROM (EEPROM), a magnetic disk, a flexible disk, an optical disk, a compact disk, a mini disk, a digital versatile disc (DVD), or the like.

Note that a part of the functions of the delay calculating device 113 and the optical phase synchronization control means 115 may be implemented by dedicated hardware, and a part thereof may be implemented by software or firmware. For example, the function of the delay calculating device 113 can be implemented by the processing circuit 51 as dedicated hardware, and the function of the optical phase synchronization control means 115 can be implemented by the processing circuit 51 reading and executing a program stored in the memory 53.

As described above, the processing circuit 51 can implement the above-described functions by hardware, software, firmware, or a combination thereof.

Note that free combinations of the individual embodiments, modifications of any components of the individual embodiments, or omissions of any components in the individual embodiments are possible.

### INDUSTRIAL APPLICABILITY

An optical beam transmission device according to the present disclosure can relax manufacturing requirements as compared with the related art, and is suitable for use in an optical beam transmission device or the like that synthesizes a plurality of optical beams in phase synchronization.

### REFERENCE SIGNS LIST

1: optical beam transmitting device, 51: processing circuit, 52: CPU, 53: memory, 101: laser light source, 102: light distributing means, 103: optical frequency shifting means, 104: collimating lens, 105: optical phase shifter, 106: optical modulator, 107: optical amplifier, 108: optical collimator array, 109: optical beam splitting means, 110: beam condensing means, 111: photoelectric converting means, 112: signal generating means, 113: delay calculating device, 114: RF variable delaying means, 115: optical phase synchronization control means, 116: optical frequency converting means, 117: optical frequency synchronization control means, 118: signal processing device, 119: signal generating means, 120: delay comparing device, 1171: PFD, 1172: LF, 1173: VCO, 1174: reference oscillator

1. An optical beam transmission device comprising:
a light distributor to split a laser beam into one local light beam and a transmission light beam for each of paths;
an optical frequency shifter to shift a frequency of the local light beam obtained by the light distributor;
a collimating lens to convert the local light beam after the frequency shift by the optical frequency shifter into a local beam that is a parallel beam;
an optical phase shifter provided for each of the paths to change a phase of a corresponding transmission light beam obtained by the light distributor in accordance with a control signal;
an optical modulator provided for each of the paths to modulate a transmission light beam after a phase change by the corresponding optical phase shifter in accordance with a modulated electrical signal;
an optical amplifier provided for each of the paths to amplify intensity of the transmission light beam after modulation by the corresponding optical modulator;
an optical collimator array provided for each of the paths to convert the transmission light beam after amplification by the corresponding optical amplifier into a transmission beam that is a parallel beam;
an optical beam splitter to split some of transmission beams obtained by the optical collimator array for each of the paths and synthesize said some of the transmission beams with the local beam obtained by the collimating lens to obtain synthesized phase monitoring light;
a photoelectric converter provided for each of the paths to photoelectrically convert corresponding synthesized phase monitoring light obtained by the optical beam splitter to obtain an electrical signal;
a modulated electrical signal outputter to output a modulated electrical signal having a controlled delay time to each of the optical modulators for each of the paths on a basis of the electrical signal obtained by the photoelectric converter for each of the paths; and
an optical phase synchronization controller provided for each of the paths to detect a phase of an electrical signal obtained by the corresponding photoelectric converter, and output a control signal based on the phase to the corresponding optical phase shifter.

2. An optical beam transmission device comprising:
a light distributor to split a laser beam into one local light beam and a transmission light beam for each of paths;
a collimating lens to convert the local light beam obtained by the light distributor into a local beam that is a parallel beam;
an optical frequency converter provided for each of the paths to transition a frequency of a corresponding transmission light beam obtained by the light distributor in accordance with a control signal;
an optical modulator provided for each of the paths to modulate a transmission light beam after a frequency transition by the corresponding optical frequency converter in accordance with a modulated electrical signal;
an optical amplifier provided for each of the paths to amplify intensity of the transmission light beam after modulation by the corresponding optical modulator;
an optical collimator array provided for each of the paths to convert the transmission light beam after amplification by the corresponding optical amplifier into a transmission beam that is a parallel beam;
an optical beam splitter to split some of transmission beams obtained by the optical collimator array for each of the paths and synthesize said some of the transmission beams with the local beam obtained by the collimating lens to obtain synthesized phase monitoring light;
a photoelectric converter provided for each of the paths to photoelectrically convert corresponding synthesized phase monitoring light obtained by the optical beam splitter to obtain an electrical signal;
a modulated electrical signal outputter to output a modulated electrical signal having a controlled delay time to each of the optical modulators for each of the paths on a basis of the electrical signal obtained by the photoelectric converter for each of the paths; and
an optical frequency synchronization controller provided for each of the paths to detect a frequency variation of an electrical signal obtained by the corresponding photoelectric converter, and output a control signal based on the frequency variation to the corresponding optical frequency converter.

3. The optical beam transmission device according to claim 1, wherein
the modulated electrical signal outputter includes:
a signal generator to generate a modulated electrical signal;
a delay calculating device provided for each of the paths to calculate a delay time difference between the electrical signal obtained by the corresponding photoelectric converter and the modulated electrical signal generated by the signal generator; and
an RF variable delaying circuit provided for each of the paths to control a delay time on a basis of the delay time difference calculated by the corresponding delay calculating device, and output the modulated electrical signal generated by the signal generator to the corresponding optical modulator.

4. The optical beam transmission device according to claim 1, wherein
the modulated electrical signal outputter includes:
a signal processing device provided for each of the paths to calculate a delay time of the electrical signal on a basis of the electrical signal obtained by the corresponding photoelectric converter, and generate a timing signal based on the delay time; and
a signal generator provided for each of the paths to output a modulated electrical signal having a common waveform to each other to the corresponding optical modulator in accordance with the timing signal generated by the corresponding signal processing device.

5. The optical beam transmission device according to claim 1, wherein
the modulated electrical signal outputter includes:
a signal generator to generate a modulated electrical signal;
a delay comparing device provided between each of pairs of the paths to calculate, on a basis of electrical signals obtained by the two corresponding adjacent photoelectric converter, a delay time difference between the electrical signals; and
an RF variable delaying circuit provided for each of the paths to control a delay time on a basis of the delay time difference calculated by the corresponding delay comparing device, and output the modulated electrical signal generated by the signal generator to the corresponding optical modulator.

6. The optical beam transmission device according to claim 2, wherein
the modulated electrical signal outputter includes:
a signal generator to generate a modulated electrical signal;
a delay calculating device provided for each of the paths to calculate a delay time difference between the electrical signal obtained by the corresponding photoelectric converter and the modulated electrical signal generated by the signal generator; and
an RF variable delaying circuit provided for each of the paths to control a delay time on a basis of the delay time difference calculated by the corresponding delay calculating device, and output the modulated electrical signal generated by the signal generator to the corresponding optical modulator.

7. The optical beam transmission device according to claim 2, wherein
the modulated electrical signal outputter includes:
a signal processing device provided for each of the paths to calculate a delay time of the electrical signal on a basis of the electrical signal obtained by the corresponding photoelectric converter, and generate a timing signal based on the delay time; and
a signal generator provided for each of the paths to output a modulated electrical signal having a common waveform to each other to the corresponding optical modulator in accordance with the timing signal generated by the corresponding signal processing device.

8. The optical beam transmission device according to claim 2, wherein
the modulated electrical signal outputter includes:
a signal generator to generate a modulated electrical signal;
a delay comparing device provided between each of pairs of the paths to calculate, on a basis of electrical signals obtained by the two corresponding adjacent photoelectric converter, a delay time difference between the electrical signals; and
an RF variable delaying circuit provided for each of the paths to control a delay time on a basis of the delay time difference calculated by the corresponding delay comparing device, and output the modulated electrical signal generated by the signal generator to the corresponding optical modulator.
